(19) United States
(12) Patent Application Publication
(10) Pub. No.: US 2023/0112574 A1
(43) Pub. Date: Apr. 13, 2023

(54) TIMING ADVANCE ACQUISITION FOR NEIGHBOR CELLS

(71) Applicant: MEDIATEK INC., Hsin-chu (TW)

(72) Inventors: LI-CHUAN TSENG, Hsin-chu (TW); Chia-Hao Yu, Hsin-chu (TW)

(21) Appl. No.: 17/939,875

(22) Filed: Sep. 7, 2022

Related U.S. Application Data
(60) Provisional application No. 63/249,093, filed on Sep. 28, 2021.

(51) Int. Cl. H04W 36/00; H04W 74/08; H04W 56/00; H04W 74/00

(52) U.S. Cl. CPC H04W 36/0061; H04W 56/0045; H04W 74/006; H04W 74/0833

(57) ABSTRACT

A method of acquiring timing advance (TA) for neighbor cells to reduce latency and interruption for inter-cell mobility is proposed. A UE is configured with a set of active cells for fast cell-switching. A neighbor cell in the active set is likely to be UE’s target cell. To reduce handover interruption, the UE acquires and maintains the TA corresponding to the cells in the active set. The UE performs early RACH for potential target cells and obtains the TA of the potential target cells. Once the UE receives handover command indicating one of the active cells as target cell, the UE can complete the handover without performing RACH again.

### CROSS REFERENCE TO RELATED APPLICATIONS

This application claims priority under 35 U.S.C. §119 from U.S. Provisional Application Number 63/249,093, entitled “Timing Advance Acquisition for Neighbor Cells”, filed on Sep. 28, 2021, the subject matter of which is incorporated herein by reference.

### TECHNICAL FIELD

The disclosed embodiments relate generally to wireless communication, and, more particularly, to a method for timing advance acquisition for neighbor cells in 5G New Radio (NR) cellular communication networks.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board has decided to focus the future NGMN activities on defining the end-to-end requirements for 5G new radio (NR) systems. In 5G NR, the base stations are also referred to as gNodeBs or gNBs.

Frequency bands for 5G NR are being separated into two different frequency ranges. Frequency Range 1 (FR1) includes sub-6GHz frequency bands, some of which are bands traditionally used by previous standards, but has been extended to cover potential new spectrum offerings from 410 MHz to 7125 MHz. Frequency Range 2 (FR2) includes frequency bands from 24.25 GHz to 52.6 GHz. Bands in FR2 in this millimeter wave range have shorter range but higher available bandwidth than bands in FR1. For UEs in RRC Idle mode mobility, cell selection is the procedure through which a UE picks up a specific cell for initial registration after power on, and cell reselection is the mechanism to change cell after UE is camped on a cell and stays in idle mode. For UEs in RRC Connected mode mobility, handover is the procedure through which a UE hands over an ongoing session from the source gNB to a neighboring target gNB.

Data may be interrupted during handover for UE reconfiguration and synchronization. Random access (RA) is usually needed during handover, as one purpose of RA is for UE to obtain timing advance (TA) of the target cell. RA occasion appears periodically, and there is some uncertain delay before UE can send preamble. The random access response (RAR) also comes with some delay (within a window). For contention-based RA (CBRA), contention resolution failure causes further delay. In LTE, RACH-less handover is possible, but it is only applicable to the restrictive use cases where TA~0 or the source TA can be reused for the target TA.

A method to reduce the data interruption due to random access during handover is desired.

### SUMMARY

A method of acquiring timing advance (TA) for neighbor cells to reduce latency and interruption for inter-cell mobility is proposed. A UE is configured with a set of active cells for fast cell-switching. A neighbor cell in the active set is likely to be UE’s target cell. To reduce handover interruption, the UE acquires and maintains the TA corresponding to the cells in the active set. The UE performs early RACH for potential target cells and obtains the TA of the potential target cells. Once the UE receives handover command indicating one of the active cells as target cell, the UE can complete the handover without performing RACH again.

In one embodiment, a UE receives a configuration in a serving cell of a mobile communication network, wherein the configuration comprises information for performing a random access channel (RACH) procedure with a neighbor cell, wherein the neighbor cell belongs to a set of active cells configured by the network. The UE performs the RACH procedure with the neighbor cell, wherein the UE acquires a timing advance (TA) of the neighbor cell. The UE receives a handover command from the network to handover from the serving cell to the neighbor cell, wherein the UE acquires the TA of the neighbor cell before receiving the handover command. The UE completes the handover to the neighbor cell without performing additional RACH procedure after receiving the handover command.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G New Radio (NR) network supporting active cell set configuration and early RACH procedure to reduce latency and interruption for inter-cell mobility in accordance with aspects of the current invention.

FIG. 2 illustrates simplified block diagrams of wireless devices, e.g., a UE and a gNB in accordance with embodiments of the current invention.

FIG. 3 illustrates one embodiment of performing early RACH procedure to reduce latency and interruption for inter-cell UE mobility.

FIG. 4 illustrates one embodiment of performing RACH toward neighbor cell using CFRA in accordance with embodiments of the current invention.

FIG. 5 illustrates another embodiment of performing RACH toward neighbor cell using CBRA in accordance with embodiments of the current invention.

FIG. 6 is a flow chart of a method for early RACH procedure and TA acquisition for neighbor cells in accordance with one novel aspect.

### DETAILED DESCRIPTION

Reference will now be made in detail to some embodiments of the invention, examples of which are illustrated in the accompanying drawings.

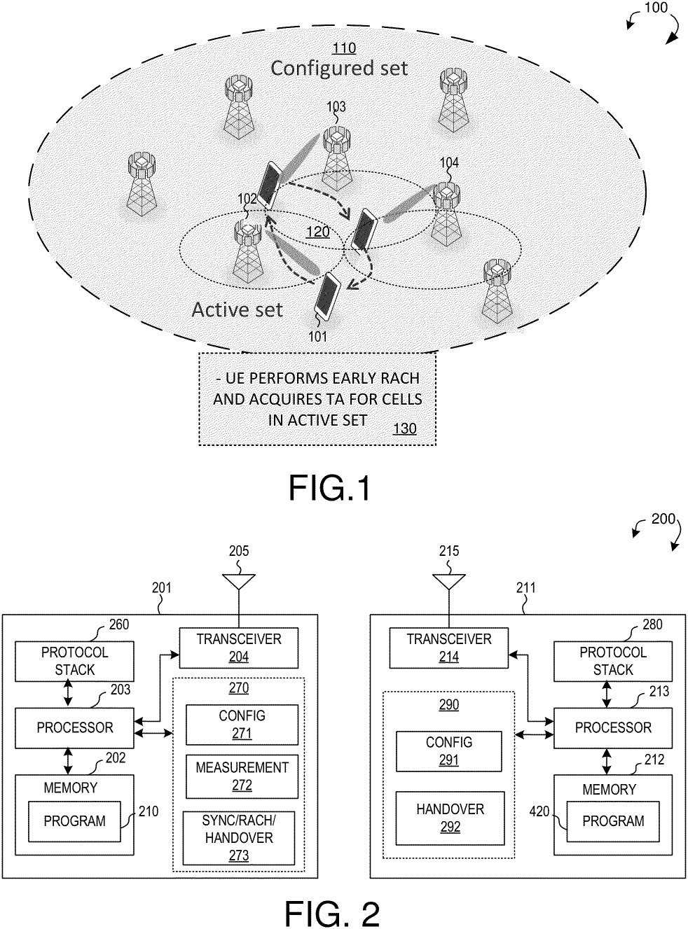

FIG. 1 illustrates an exemplary 5G New Radio (NR) network 100 supporting active cell set configuration and early RACH procedure to reduce latency and interruption for inter-cell mobility in accordance with aspects of the current invention. The 5G NR network 100 comprises a User Equipment (UE) 101 and a plurality of base stations including gNB 102, gNB 103, and gNB 104. UE 101 is communicatively connected to a serving gNB 102, which provides radio access using a Radio Access Technology (RAT) (e.g., the 5G NR technology). The UE 101 may be a smart phone, a wearable device, an Internet of Things (IoT) device, and a tablet, etc. Alternatively, UE 101 may be a Notebook (NB) or Personal Computer (PC) inserted or installed with a data card which includes a modem and RF transceiver(s) to provide the functionality of wireless communication.

The 5G core function receives all connection and session related information and is responsible for connection and mobility management tasks. For UEs in radio resource control (RRC) Idle mode mobility, cell selection is the procedure through which a UE picks up a specific cell for initial registration after power on, and cell reselection is the mechanism to change cell after UE is camped on a cell and stays in idle mode. For UEs in RRC Connected mode mobility, handover is the procedure through which a UE hands over an ongoing session from the source gNB to a neighboring target gNB. UE 101 is not always served by the best cell/beam due to mobility latency, which is due to the time spent on measurement report, handover command, and handover execution. Data may be interrupted during handover for UE reconfiguration and synchronization. In case of short cell/beam dwelling time (e.g., in FR2), the percentage of time when UE is served by an inferior cell/beam, or with service interruption, can be significant.

Data may be interrupted during handover for UE reconfiguration and synchronization. Random access (RA) is usually needed during handover, as one purpose of RA is for UE to obtain timing advance (TA) of the target cell. RA occasion appears periodically, and there is some uncertain delay before UE can send preamble. The random access response (RAR) also comes with some delay (within a window). For contention-based RA (CBRA), contention resolution failure causes further delay. In LTE, RACH-less handover is possible, but it is only applicable to the restrictive use cases where TA~0 or the source TA can be reused for the target TA.

In accordance with one novel aspect, a method of acquiring timing advance (TA) for neighboring cells to reduce latency and interruption for inter-cell mobility is proposed. In dense deployment, UE 101 is configured with a set of configured cells and a set of active cells. For the configured set 110, the configured cells that are prepared (i.e., possessing UE context), and UE processes and maintains the configurations for the cells. For the active set 120, UE 101 can do fast switching among the active cells. A non-serving active cell in the active set is likely to become a target cell for handover, and UE 101 can switch to the target cell in the active set via a low-latency network handover signaling (e.g., L1 or MAC signaling). As depicted by 130, to reduce handover interruption, UE 101 acquires and maintains the TA corresponding to the cells in the active set. UE 101 performs early RACH for potential target cell(s) and obtains the TA. Once UE 101 receives handover command indicating one of the active cells as target cell, UE 101 no longer needs to perform RACH and thus the handover interruption time is reduced.

FIG. 2 illustrates simplified block diagrams of wireless devices, e.g., a UE 201 and a gNB 211 in accordance with embodiments of the current invention in 5G NR network 200. The gNB 211 has an antenna 215, which transmits and receives radio signals. An RF transceiver module 214, coupled with the antenna 215, receives RF signals from the antenna 215, converts them to baseband signals and sends them to the processor 213. The RF transceiver 214 also converts received baseband signals from the processor 213, converts them to RF signals, and sends out to the antenna 215. The processor 213 processes the received baseband signals and invokes different functional modules to perform features in the gNB 211. The memory 212 stores program instructions and data 220 to control the operations of the gNB 211. In the example of FIG. 2, the gNB 211 also includes a protocol stack 280 and a set of control function modules and circuits 290. The protocol stack 280 may include a Non-Access-Stratum (NAS) layer to communicate with an AMF/SMF/MME entity connecting to the core network, a Radio Resource Control (RRC) layer for high layer configuration and control, a Packet Data Convergence Protocol/Radio Link Control (PDCP/RLC) layer, a Media Access Control (MAC) layer, and a Physical (PHY) layer. In one example, the control function modules and circuits 290 include a configuration circuit for configuring measurement report and active set for UE, and a handover handling circuit for sending cell-switch to the UE upon handover decision.

Similarly, the UE 201 has a memory 202, a processor 203, and an RF transceiver module 204. The RF transceiver 204 is coupled with the antenna 405, receives RF signals from the antenna 205, converts them to baseband signals, and sends them to the processor 203. The RF transceiver 204 also converts received baseband signals from the processor 203, converts them to RF signals, and sends out to the antenna 205. The processor 203 processes the received baseband signals (e.g., comprising cell addition/activation commands) and invokes different functional modules and circuits to perform features in the UE 201. The memory 202 stores data and program instructions 210 to be executed by the processor 203 to control the operations of the UE 201. Suitable processors include, by way of example, a special purpose processor, a Digital Signal Processor (DSP), a plurality of microprocessors, one or more micro-processor associated with a DSP core, a controller, a microcontroller, Application Specific Integrated Circuits (ASICs), File Programmable Gate Array (FPGA) circuits, and other type of Integrated Circuits (ICs), and/or state machines. A processor in associated with software may be used to implement and configure features of the UE 201.

The UE 201 also includes a protocol stack 260 and a set of control function modules and circuits 270. The protocol stack 260 may include a NAS layer to communicate with an AMF/SMF/MME entity connecting to the core network, an RRC layer for high layer configuration and control, a PDCP/RLC layer, a MAC layer, and a PHY layer. The Control function modules and circuits 270 may be implemented and configured by software, firmware, hardware, and/or combination thereof. The control function modules and circuits 270, when executed by the processor 203 via program instructions contained in the memory 202, interwork with each other to allow the UE 201 to perform embodiments and functional tasks and features in the network. In one example, the control function modules and circuits 270 include a configuration circuit 271 for obtaining configuration information of active set and pre-RACH, a measurement circuit 272 for performing and reporting measurements, and a sync/RACH/handover handling circuit 273 for performing (pre)-synchronization, (pre)-RACH, and handover procedure based on the configuration and HO command received from the network.

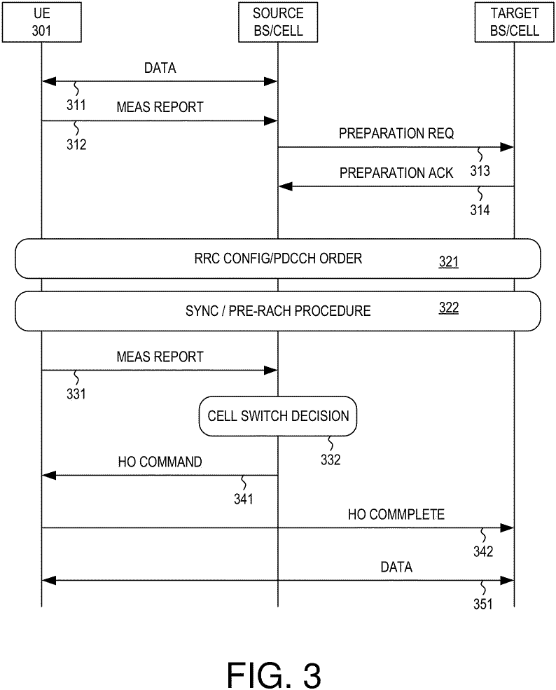

FIG. 3 illustrates one embodiment of performing early RACH procedure to reduce latency and interruption for inter-cell UE mobility. In step 311, UE 301 performs data transmission and reception with a serving base station in a serving cell. In step 312, UE 301 performs measurements of neighboring cells and sends measurement report to the serving gNB. In step 313, the source gNB sends a preparation request to one or more target base station(s). In step 314, the target gNB sends a preparation acknowledgement back to the source gNB. In step 321, the source gNB can then provide RRC configuration/PDCCH order to UE 301 for a set of active cells and for early RACH procedure. The RRC configurations comprise information for UE to perform DL and UL synchronization on the active cells (i.e., potential target cells), and common and dedicated configurations required when the active cell becomes UEs' serving cell.

In step 322, UE 301 performs synchronization and pre-RACH procedure for TA acquisition of neighbor cell(s). In the downlink, UE 301 performs fine time-frequency tracking for at least some beams of the active cells. In the uplink, UE 501 performs pre-RACH for timing advance acquisition of the active cells. The pre-RACH can be triggered by two alternatives. In a first alternative, the UE performs RACH upon receiving the RRC configuration, e.g., when a neighbor cell is added to the active set. In a second alternative, the UE performs RACH upon receiving the PDCCH order, e.g., the network may add a cell to active set first using RRC configuration, and then trigger RACH later using PDCCH order. The DL reception timing reference for transmitting the PRACH may be based on a serving cell, or based on the neighbor cell. The RACH can be contention-free random access (CFRA). RRC configuration or PDCCH order may provide configurations for UE to perform CFRA, e.g., SSB index and preamble index. The RACH can be contention-based random access (CBRA). After RACH, UE 301 acquires the TA for the active cells, but does not change serving cell immediately.

In step 331, UE 301 performs measurements of neighboring cells and sends measurement report to the serving gNB. In step 332, the serving gNB makes cell-switching decisions based on the measurement report. In step 341, the serving gNB sends an HO command message to UE 301. Upon receiving the HO command, UE 301 applies target cell configuration. The HO command can be L1/L2/L3 signal. In step 342, UE 301 sends an HO complete message to the target gNB, and the handover procedure is completed. In step 351, UE 301 starts data transmission and reception in the target cell. Because UE maintains the target cell configuration, and performs synchronization and RACH with the target cell before receiving the HO command, HO interruption time is reduced.

While performing pre-RACH towards neighbor cell, the UE is still served by its serving cell. Depending on UE capability (e.g., whether UE has extra set of RF module), the communication on serving cell and the RACH towards neighbor cell can be done in parallel. In some cases, the PRACH transmission of the neighbor cell and the UL transmission of the serving cell are scheduled at the same time. If total TX power exceeds a maximum value, the TX power of individual cells are scaled down by a same factor. If total TX power exceeds a maximum value, one of the PRACH transmissions is prioritized whereas the other one is dropped. The prioritized transmission can be RACH or transmission on the serving cell. In some other cases, the RACH transmissions are not allowed to take place at the same time. In one example, the RACH towards the configured cell may be prioritized over the transmissions on serving cell. In some implementation, the RACH transmission is prioritized over a subset of signals from the serving cell. For example, the RACH may not be prioritized over serving cell RACH transmission. In another example, RACH towards the configured cell may be deprioritized.

Depending on UE capability, the communication on serving cell and the RACH towards neighbor cell cannot be performed by the UE in parallel for certain UEs. UE can send RACH preamble towards the neighbor cell by using scheduling gaps in the serving cell, and monitor RAR for the neighbor cell in the serving cell (i.e., RAR can be forwarded by the serving cell). Alternatively, UE can send preamble and receives RAR to/from the neighbor cell using gaps in the serving cell. The gaps in the serving cell align with RACH procedure so that UE does not lose data transmission from the serving cell.

In Contention Free Random Access (CFRA), the Preamble is allocated by the gNodeB, and such preambles are known as dedicated random access preamble. The dedicated preamble is provided to UE either via RRC signaling (allocating preamble can be specified within an RRC message) or PHY Layer signaling (DCI on the PDCCH). Therefore, there is no preamble conflict. When dedicated resources are insufficient, the gNodeB instructs UEs to initiate contention-based RA. CFRA is also known as three step RACH procedure: Step 1 - Random Access Preamble Assignment; Step 2 - Random Access Preamble Transmission (Msg1); Step 3 - Random Access Response (RAR) (Msg2), which contains TA information.

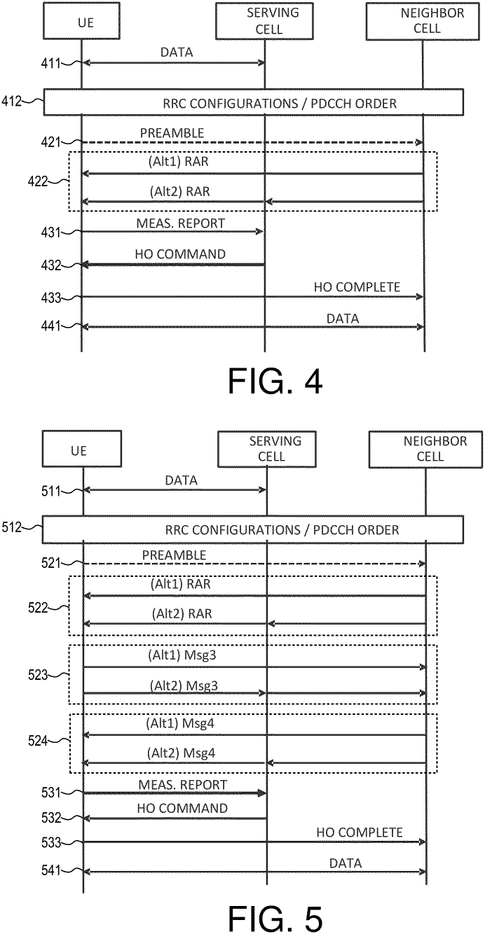

FIG. 4 illustrates one embodiment of performing RACH toward neighbor cell using CFRA in accordance with embodiments of the current invention. In step 411, UE 401 performs data transmission and reception with a serving base station in a serving cell. In step 412, the source gNB provides RRC configuration/PDCCH order to UE 401 for a set of active cells and for triggering RACH procedure with a neighbor cell (e.g., from the set of active cells). The RRC configurations comprise information for UE to perform DL and UL synchronization on the active cells, and common and dedicated configurations required when an active cell becomes the UEs' serving cell. The RRC/PDCCH order further comprises dedicated preamble assignment information for the upcoming CFRA procedure.

In step 421, UE 401 performs synchronization and RACH procedure for TA acquisition of neighbor cell(s), by sending a RACH preamble (Msg1) to the neighbor cell. UE 401 can send the RACH preamble towards the neighbor cell by using gaps in the serving cell. The gaps in the serving cells align with RACH procedure so that UE does not lose data transmission from the serving cell. In step 422, UE 401 then monitors a random access response RAR (Msg2) from the neighbor cell. In a first alternative, UE 401 monitors RAR transmitted from the neighbor cell directly, using gaps in the serving cell. In one example, individual gaps for msg-1 TX and msg-2 RX from the neighbor cell are used. Between the gaps, UE may monitor activity of the serving cell. In a second alternative, the RAR is sent by the neighbor cell and then forwarded by the serving cell to the UE. UE 401 acquires and maintains the TA and configurations of the neighbor cell upon completion of the RACH procedure.

In step 431, UE 401 performs measurements of neighboring cells and sends measurement report to the serving gNB. In step 432, the serving gNB makes cell-switching decisions based on the measurement report, and sends an HO command message to UE 401. Upon receiving the HO command, UE 401 applies target cell configuration. The HO command can be L1/L2/L3 signal. In step 433, UE 401 sends an HO complete message to the target gNB, and the handover procedure is completed. In step 441, UE 401 starts data transmission and reception in the target cell. Because UE maintains the target cell configuration, and performs synchronization and pre-RACH to acquire TA for the target cell before receiving the HO command, the handover interruption time is reduced.

In contention based Random access (CBRA), UE selects a Preamble randomly from a pool of preambles shared with other UEs. This means that the UE has a potential risk of selecting the same preamble as another UE and subsequently may experience conflict or contention. The gNodeB uses a contention resolution mechanism to handle this type of access requests. In CBRA procedure, the result is random and not all Random Access succeeds. CBRA is also known as four step RACH Procedure: Step 1 - Random Access Preamble Transmission (Msg1); Step 2 - Random Access Response (RAR) (Msg2); Step 3 - Schedule Uplink Transmission (Msg3); and Step 4 - Contention Resolution (Msg4).

FIG. 5 illustrates another embodiment of performing RACH toward neighbor cell using CBRA in accordance with embodiments of the current invention. In step 511, UE 501 performs data transmission and reception with a serving base station in a serving cell. In step 512, the source gNB provides RRC configuration/PDCCH order to UE 501 for a set of active cells and for triggering RACH procedure with a neighbor cell (e.g., from the set of active cells). The RRC configurations comprise information for UE to perform synchronization on the active cells, and common and dedicated configurations required when an active cell becomes the UEs' serving cell.

In step 521, UE 501 performs DL synchronization and RACH procedure for TA acquisition of neighbor cell(s), by sending a RACH preamble (Msg1) to the neighbor cell. UE 501 can send the RACH preamble towards the neighbor cell by using gaps in the serving cell. In step 522, UE 501 then monitors a random access response RAR (Msg2) from the neighbor cell. In a first alternative, UE 501 monitors RAR transmitted from the neighbor cell directly, using gaps in the serving cell. In a second alternative, the RAR sent from the neighbor cell is forwarded by the serving cell to UE 501.

In step 523, UE 501 send Msg3 to the neighbor cell, which can be scheduled by the network on the serving cell or the neighbor cell, preferably on the serving cell. In a first alternative, UE 501 sends Msg3 to the neighbor cell directly. In a second alternative, UE 501 sends Msg3 to the serving cell, which is then forwarded to the neighbor cell. If the Msg3 transmission is scheduled by Msg2, then the transmission may not require a gap. An additional guard period may be required before and after Msg3 resources. Subsequently, in step 524, UE 501 monitors Msg4 from the neighbor cell or from the serving cell, preferably from the serving cell. In a first alternative, UE 501 receives Msg4 from the neighbor cell directly. In a second alternative, UE 501 receives Msg4 from the serving cell, which forwards Msg4 from the neighbor cell to UE 501. An additional time window may be defined for Msg4 reception in the neighbor cell.

In step 531, UE 501 performs measurements of neighboring cells and sends measurement report to the serving gNB. In step 532, the serving gNB makes cell-switching decisions based on the measurement report, and sends an HO command message to UE 501. Upon receiving the HO command, UE 501 applies target cell configuration. The HO command can be L1/L2/L3 signal. In step 533, UE 501 sends an HO complete message to the target gNB, and the handover procedure is completed. In step 541, UE 501 starts data transmission and reception in the target cell. Because UE maintains the target cell configuration, and performs synchronization and pre-RACH to acquire TA for the target cell before receiving the HO command, the handover interruption time is reduced.

PDCCH order can be used for triggering UE to perform the RACH procedure for neighbor cell(s). In a first alternative, the DCI field of the PDCCH-order may indicate RACH procedure towards one of neighboring cells (e.g., neighbor cell ID). A configuration associated with this PDCCH-order may indicate only a subset of PRACH resources, with others to be selected by UE. In one example, the preamble sequence may be indicated by the network. In another example, the RACH occasion/resource may be selected by UE based on UE measurement, e.g., UE TX beam, pathloss RS. Note that an initial RACH transmission opportunity may be configured within a time window after the PDCCH order. In a second alternative, the DCI field of the PDCCH-order may carry information on which RACH occasion/resource from a configuration to perform. Thus, the DCI field carries information for providing QCL-typeD reference (beam) for deciding PRACH beam direction, power control reference signal (pathloss RS), etc.

The RAR reception may be from the serving cell or from the neighbor cell. If RAR is from the serving cell, UE may assume the same beam (QCL-typeD) as for the PDCCH-order reception. If RAR is from the neighbor cell, UE may assume the same beam (QCL-typeD) as for the last RACH transmission. Similarly, Msg-3/msg-4 TX/RX may be from the serving cell or from the neighbor cell. If from the serving cell, UE may assume the same beam (QCL-typeD) as for the PDCCH-order reception. If from the neighbor cell, UE may assume the same beam (QCL-typeD) as for the last RACH transmission.

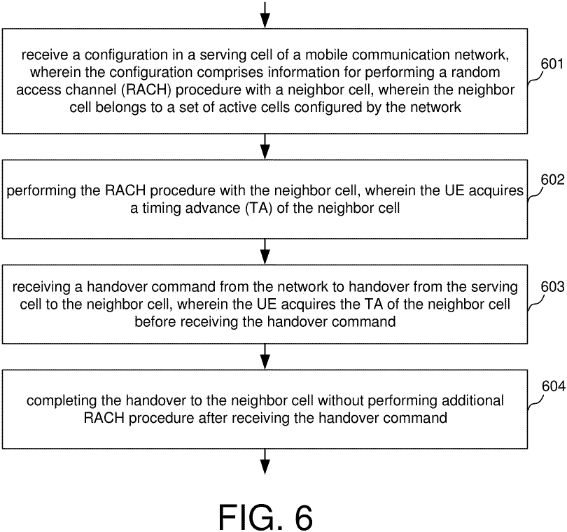

FIG. 6 is a flow chart of a method for early RACH procedure and TA acquisition for neighbor cells in accordance with one novel aspect. In step 601, a UE receives a configuration in a serving cell of a mobile communication network, wherein the configuration comprises information for performing a random access channel (RACH) procedure with a neighbor cell, wherein the neighbor cell belongs to a set of active cells configured by the network. In step 602, the UE performs the RACH procedure with the neighbor cell, wherein the UE acquires a timing advance (TA) of the neighbor cell. In step 603, the UE receives a handover command from the network to handover from the serving cell to the neighbor cell, wherein the UE acquires the TA of the neighbor cell before receiving the handover command. In step 604, the UE completes the handover to the neighbor cell without performing additional RACH procedure after receiving the handover command.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving a configuration by a User Equipment (UE) in a serving cell of a mobile communication network, wherein the configuration comprises information for performing a random access channel (RACH) procedure with a neighbor cell, wherein the neighbor cell belongs to a set of active cells configured by the network;
performing the RACH procedure with the neighbor cell, wherein the UE acquires a timing advance (TA) of the neighbor cell;
receiving a handover command from the network to handover from the serving cell to the neighbor cell, wherein the UE acquires the TA of the neighbor cell before receiving the handover command; and
completing the handover to the neighbor cell without performing additional RACH procedure after receiving the handover command.

2. The method of claim 1, wherein the RACH procedure with the neighbor cell is configured and triggered by a radio resource control (RRC) signaling.

3. The method of claim 1, wherein the RACH procedure with the neighbor cell is triggered by a physical downlink control channel (PDCCH) order.

4. The method of claim 1, wherein the UE performs the RACH procedure with the neighbor cell and communicates with the serving cell in parallel.

5. The method of claim 4, wherein a TX power for the neighbor cell and for the serving cell are scaled down based on the same or different scaling factors.

6. The method of claim 4, wherein the UE prioritizes between the RACH transmission on the neighbor cell and the uplink transmission on the serving cell.

7. The method of claim 1, wherein the UE performing the RACH with the neighbor cell using scheduling gaps in the serving cell.

8. The method of claim 7, wherein the UE receives a Msg3 from the neighbor cell or transmits a Msg4 to the neighbor cell that is forwarded by the serving cell.

9. The method of claim 7, wherein the UE monitors activity of the serving cell between the gaps.

10. The method of claim 1, wherein the RACH procedure is triggered by a downlink control information (DCI) field of a physical downlink control channel (PDCCH) order.

11. A User Equipment (UE), comprising:
a receiver that receives a configuration in a serving cell of a mobile communication network, wherein the configuration comprises information for performing a random access channel (RACH) procedure with a neighbor cell, wherein the neighbor cell belongs to a set of active cells configured by the network;
a RACH handling circuit that performs the RACH procedure with the neighbor cell, wherein the UE acquires a timing advance (TA) of the neighbor cell; and
a handover handling circuit that receives a handover command from the network to handover from the serving cell to the neighbor cell, wherein the UE acquires the TA of the neighbor cell before receiving the handover command. And wherein the UE completes the handover to the neighbor cell without performing additional RACH procedure after receiving the handover command.

12. The UE of claim 11, wherein the RACH procedure with the neighbor cell is configured and triggered by a radio resource control (RRC) signaling.

13. The UE of claim 11, wherein the RACH procedure with the neighbor cell is triggered by a physical downlink control channel (PDCCH) order.

14. The UE of claim 11, wherein the UE performs the RACH procedure with the neighbor cell and communicates with the serving cell in parallel.

15. The UE of claim 14, wherein a TX power for the neighbor cell and for the serving cell are scaled down based on the same or different scaling factors.

16. The UE of claim 14, wherein the UE prioritizes between the RACH transmission on the neighbor cell and the uplink transmission on the serving cell.

17. The UE of claim 11, wherein the UE performing the RACH with the neighbor cell using scheduling gaps in the serving cell.

18. The UE of claim 17, wherein the UE receives a Msg3 from the neighbor cell or transmits a Msg4 to the neighbor cell that is forwarded by the serving cell.

19. The UE of claim 17, wherein the UE monitors activity of the serving cell between the gaps.

20. The UE of claim 11, wherein the RACH procedure is triggered by a downlink control information (DCI) field of a physical downlink control channel (PDCCH) order.
